(19) United States
(12) Patent Application Publication
(10) Pub. No.: US 2025/0180834 A1
(43) Pub. Date: Jun. 5, 2025

(54) SYSTEM AND METHODS FOR COUPLING LIGHT TO ON-CHIP DEVICES

(71) Applicant: PHOTONIC INC., Coquitlam (CA)

(72) Inventor: Gary WOLFOWICZ, Vancouver (CA)

(21) Appl. No.: 18/964,219

(22) Filed: Nov. 29, 2024

Related U.S. Application Data
(60) Provisional application No. 63/605,075, filed on Dec. 1, 2023.

(51) Int. Cl. G02B 6/42; G01D 5/353

(52) U.S. Cl. CPC G02B 6/4214; G01D 5/35306

(57) ABSTRACT

Distances between photonic integrated circuits and multiport optical probes can be established by emitting an optical beam from a first optical port of the multiport optical probe so that the optical beam is coupled into a first waveguide section of a PIC. This optical beam portion is reflected from a surface of the multiport optical probe back to the PIC. At suitable PIC-probe distances, the optical beam is coupled by a second waveguide grating to propagate in a second waveguide section and is then emitted to a second optical port of the multiport optical probe by a third waveguide grating coupler and directed to a detector. The detector signal is used to determine or adjust PIC-probe separation.

### CROSS REFERENCE TO RELATED APPLICATION

This application claims the benefit under 35 U.S.C. § 119 of U.S. application No. 63/605,075 filed Dec. 1, 2023 and entitled SYSTEM AND METHODS FOR COUPLING LIGHT TO ON-CHIP DEVICES, which is hereby incorporated herein by reference for all purposes.

### FIELD

The disclosure pertains to optical coupling to photonic integrated circuits.

### BACKGROUND

Efficient coupling of light between an optical fiber and photonic devices integrated on a chip can be challenging to achieve. Two common methods for coupling light into and out of a photonic integrated circuit (PIC) involve the use of grating couplers or edge couplers. Grating couplers can be situated at any location on a PIC but typically have a limited bandwidth based on grating bandwidth. Edge couplers provide large bandwidth but can require additional cleaving and polishing operations to create the necessary PIC facet.

One approach to optically coupling a PIC to an optical fiber is to situate an end surface of the optical fiber to be coupled to a PIC within a Rayleigh range of an optical beam from an on-chip grating coupler. Within the Rayleigh range, an optical beam can be considered to maintain collimation due to limited beam expansion in this range. However, suitably situating a fiber end surface is difficult as typical Rayleigh ranges of optical beams associated with grating couplers are on the order of a few tens of microns while the optical fibre or fibres and optical probe to be coupled have dimensions of a few mm to a few cm. Micron level placement over such large areas can require time-consuming, precise alignments and improved approaches are needed.

### SUMMARY

The disclosure pertains to measuring and adjusting distances between multiport optical probes (or optical waveguides) and photonic integrated circuits (PICs) for providing suitable optical coupling between one or more optical ports of the multiport optical probe and the PIC. In the examples, an optical beam emitted by one of the PIC or the multiport optical probe is reflected from the multiport optical probe or the PIC, respectively, at least once. A detector signal responsive to the reflected beam is used to establish the distance. In some cases, the detector signal is an interference signal based on the reflected optical signal and an optical signal produced on the PIC by, for example, reflection.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 illustrates a representative system for establishing distances between photonic integrated circuits (PICs) and multiport optical probes using reflection from the multiport optical probe.

FIG. 2A is a perspective view of a representative arrangement of a PIC and a multiport optical probe for establishing PIC-probe distances using a swept wavelength optical beam and reflection from the multiport optical probe to produce a detector signal based on interference.

FIG. 2B illustrates a representative system for establishing PIC-probe distances using a swept wavelength optical beam and reflection from a reflective area of a multiport optical probe to produce a detector signal based on interference.

FIG. 3A contains plots of optical signal power as a function of wavelength for interferometry-based PIC-probe distance determination as illustrated in FIGS. 2A-2B.

FIG. 3B contains plots associated with Fourier transforms of the calculated data of FIG. 3A that permit determination of PIC-probe distance.

FIG. 4 illustrates a representative system for establishing PIC-probe distance using multiple reflections from the multiport optical probe and the PIC.

FIG. 5 illustrates a representative system for establishing PIC-probe distances using a swept wavelength optical beam and reflection from a reflective area of a multiport optical probe to produce a detector signal based on interference of optical beams returned to an optical port which is also used to provide the swept wavelength optical beam to the PIC.

FIG. 6 illustrates a representative method of establishing PIC-probe distances using optical beam portions reflected from a multiport optical probe.

FIG. 7 illustrates a representative computer environment for implementation of any of the disclosed methods, systems, and apparatus.

FIG. 8 illustrates a representative method of establishing PIC-probe distances using optical beam portions reflected from the multiport optical probe.

FIG. 9 illustrates a representative method of establishing PIC-probe distances using optical beam portions reflected from the multiport optical probe to produce a detector signal based on optical interference.

FIG. 10 illustrates a representative method of establishing PIC-probe distances using optical beam portions reflected from the multiport optical probe.

FIG. 11 illustrates a portion of a representative multiport optical probe.

FIG. 12 illustrates a representative system for establishing distances between photonic integrated circuits (PICs) and multiport optical probes using reflection from the multiport optical probe with an optical source situated on the PIC.

FIG. 13 illustrates a representative system for establishing distances between photonic integrated circuits (PICs) and multiport optical probes using reflection from the multiport optical probe with an optical detector situated on the PIC.

### DETAILED DESCRIPTION

Disclosed herein are methods, systems, and apparatus that can determine suitable or optimal coupling distances between an optical fibre end and a photonic integrated circuit (PIC) or other arrangement of optical waveguides on a substrate. In typical examples, a guided optical beam from a PIC is emitted from the PIC for reflection from an external surface such as a surface of a multiport optical probe. The reflected optical beam is coupled to the PIC and caused to propagate as a guided optical beam that is then emitted from the PIC to a second optical port of the multiport optical probe. Based on a portion of the optical beam coupled into the second optical port, a suitable coupling distance between the multiport optical probe and the PIC can be determined. More generally, the disclosure pertains to methods and apparatus for establishing suitable distances and coupling optical beams to and from multiport optical devices such as photonic integrated circuits and multiport optical probes.

### Terminology

As used herein, “port” or “optical port” refers to an input or output portion of an optical waveguide such as an optical fibre. Optical ports can be arranged to couple optical beams into or out of waveguide devices such photonic integrated circuits. Optical coupling to planar substrates can be provided via a major surface of a waveguide substrate using waveguide couplers such as waveguide grating couplers. In some examples, multiport optical devices comprise arrays of optical waveguides such as optical fibres that are fixed with respect to each. Examples are described generally with reference to coupling of photonic integrated circuits (PICs) and multiport optical probes. However, the disclosed methods and apparatus are suitable for coupling optical beams to, from, and between arbitrary multiport optical devices or single port optical devices.

Photonic integrated circuits (PICs) generally include one or more optical waveguides defined in a plane at or near a major surface of a substrate. PICs can be fabricated using a wide variety of materials such as silicon-on-insulator (SOI), gallium-arsenide (GaAs), and indium phosphide (InP), and others. As an example, a PIC can be formed using a SOI approach that typically consists of a thin (about 100-500 nm) device layer of silicon on a thick (1-5 μm) buried oxide (BOX) layer of silicon dioxide which is in turn on a thick (50-1,000 μm) layer (handle layer) of silicon. One or more optical sources, detectors, modulators, switches, splitters, and/or waveguides can be provided by a PIC, and a PIC can be situated to be optically coupled to external optical sources, detectors, modulators, and/or waveguides as well. Optical devices that are part of a PIC are referred to as “integrated.”

Waveguide grating couplers redirect optical beams propagating to a PIC from an optical port of a multiport optical probe to propagate as guided optical beams in the PIC or to redirect guided optical beams propagating the PIC out of the PIC. Waveguide grating couplers can be situated as needed on the major surface of a PIC substrate. In some examples, grating couplers have a total on-chip footprint on the order of 10-100 μm by 10-100 μm. Waveguide Grating couplers are described in greater detail in Marchetti et al., “High-efficiency grating-couplers: demonstration of a new design strategy,” Scientific Reports, doi.org/10.1038/s41598-017-16505-z (2017) which is incorporated herein by reference.

Optical ports whether defined by optical fibres or waveguide grating couplers or otherwise can be situated in regular arrays in a linear or a two-dimensional array with a fixed or variable spacing between the optical ports, but optical ports can be arranged in other ways as well.

Multiport optical probes comprise a series of optical waveguides such as optical fibres that are fixed with respect to each other at first ends to provide optical ports for optical communication with an optical device such as a PIC. Second fibre ends can be coupled to detectors, sources, or modulators or other optical devices. The fibre ends can be cleaved or polished for coupling to external devices and for coupling to PICS. The optical ports of a multiport optical probe are typically arranged in a uniformly spaced linear array, but two-dimensional arrays and non-uniform spacings can be used. Such multiport probes generally do not (but may) include active optical elements such as sources, detectors, modulator, switches but typically serve only to couple optical beams to and from a PIC or other multiport optical device. Such multiport optical probes are commercially available through vendors such as Fibre Tech Optica (https://fibertech-optica.com/fiber-optic-probes/). These multiport probes provide precise placement of the fibre ends relative to each other and may be secured by a metal, ceramic, or glass elements that can fix fibre ends in place, offer surfaces that can be secured to positioning stages, and that can protect fiber ends from damage. Adhesives can also be used to secure and surround the optical fibres. Multiport probes permit placement of multiple optical ports at or near a major surface or an edge surface of a multiport optical device such as a PIC, typically within 50 μm or less. In most practical examples, optical port spacings of photonic integrated circuits and multiport optical probes are selected to be the same and can include a few optical ports or many such as thousands of optical ports.

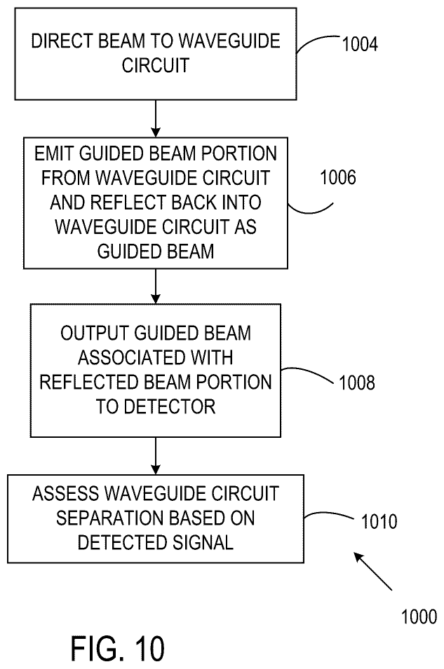

Referring to FIG. 11, a representative multiport optical probe 1100 includes a support member comprising a top element 1110 and a bottom element 1112 that secure a plurality of optical waveguides that terminate at a probe face 1118. As shown, the multi-port optical probe 1100 includes optical ports 1102-1105 defined by corresponding optical fibres and are secured between the top element 1110 and the bottom element 1112 in an inset 1114 that includes an upper portion 1114B and a lower portion 1114A. In this example, the lower portion 1114A of the inset 1114 has a plurality of grooves that align the optical fibres 1102-1105. An adhesive layer 1116 can be provided to secure the lower and upper portions 1114A, 1114B of the inset 1114 to each other. The probe face 1118 is defined by surfaces of the top element 1110, the bottom element 1112, and a surface of the inset 1114. Typically, the probe face 1118 is polished or otherwise specularly reflective so that portions of optical beams directed to the probe face 1118 can be reflected by surfaces of one or more of the top element 1110, the bottom element 1112, the inset 1114, or optical ports defined by the fibres 1102-1105. For convenience, components situated to fix optical ports in a multiport optical probe are referred to as forming a fiber support matrix, regardless of whether one or more components are used. In this example, the fiber support matrix includes the top element 1110, the bottom element 1112, the inset 1114, and the adhesive layer 1116. A fiber support matrix can generally include metal, plastic, ceramic, adhesives, or other materials that fix optical port locations or sleeves, tubes, or ferrules that surround and fix the fibres 1102-1105 in place. The support matrix of FIG. 11 is only a representative example. A probe face such as the probe face 1118 is thus defined by the fiber support matrix and the optical ports associated with the optical fibres 1102-1105. While substantially the entire probe face 1118 can be polished or otherwise reflective, in some examples, only portions of a probe face at or near the optical ports are reflective. For example, in FIG. 11, a portion of the probe face 1118 associated with the inset 1114 can be reflective while other portions are less so or are not. A probe face can be circular, rectangular, or other shape.

As discussed above, waveguide grating couplers are convenient for coupling unguided optical beams such as those from a multiport optical probe into waveguide devices such as PICs for propagation as guided optical beams. Input and output beam angles are based on Bragg grating design. For purposes of illustration, beam angles in the drawings that are associated with optical beams directed to and from such beam coupler are not shown to scale and angles are illustrative and not to scale.

As used herein, “beam” or “optical beam” refers to propagating electromagnetic radiation at wavelengths between 200 nm and 10 μm. Beams can be guided or unguided and propagate in a bulk medium or in a waveguide. In some examples, such beams are collimated and have angular diameters of less than 1, 2, 5, 10, or 20 degrees. Typically, such beams are provided as laser beams for convenient, efficient coupling but either coherent, partially coherent, or incoherent beams can be used. Reflectors and reflective surfaces as used herein can be based on metallic or dielectric materials including metallic and dielectric thin films and can refer to surfaces that provide Fresnel reflection based on differences in indices of refraction. “Beam splitter” or “beam divider” refers to an optical device that divides an input optical beam into two or more output optical beams and/or that can combine portions of two or more input optical beams to co-propagate. A typical example for waveguide devices is an optical directional coupler that can have one or more waveguide inputs and that can couple these waveguide inputs to one or more output waveguides; for unguided beams, cube and plate beam splitters are representative examples. In any case, a split ratios need not 50/50 and can be set as needed or convenient.

In some examples, interferometric detector signals are produced by combining an optical beam portion that is reflected from a surface exterior to a PIC and reflected optical signal produced on the PIC. In other examples, an optical beam produced on a PIC is obtained by routing an optical beam along a waveguide and then combined with an optical beam portion obtained by external reflection using a beam splitter, without requiring a reflector.

As used herein, positioning devices for one or both of rotational and translation motion are referred to as “positioning stages” or “stages.” Such stages can be based on combinations of positioning hardware that can be secured together. The examples are generally described with a positioning stage operable to adjust one of a photonic integrated circuit or a multiport optical probe, but a stage or stages can be provided for translation and rotation of both.

In the drawings, optical beams are generally represented with relatively heavy lines having arrows indicating directions of optical beam propagation; paths associated with optical beams propagating in two directions are indicated with arrows on both ends of the associated line. Combined optical beams such as those used to produce interference-based optical signals are shown as relatively heavy dashed lines with arrows indicating direction of propagation. In some cases, optical beams that propagate along the same path are shown as side-by-side lines for ease of illustration.

“Signal, “detector signal,” and similar terms refer to time-varying voltages or currents produced by a photodetector (“detector”) in response to an incident optical beam. These terms also encompass corresponding stored representations of such signals such as digital representations thereof.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items unless otherwise indicated or required.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus are referred to as “lowest”, “best”, “minimum,” or the like. It will be appreciated that such descriptions are intended to indicate that a selection among many functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation. Some examples are described with reference to particular coordinate systems for convenient illustration as well, but other coordinate systems can be used.

### Example 1

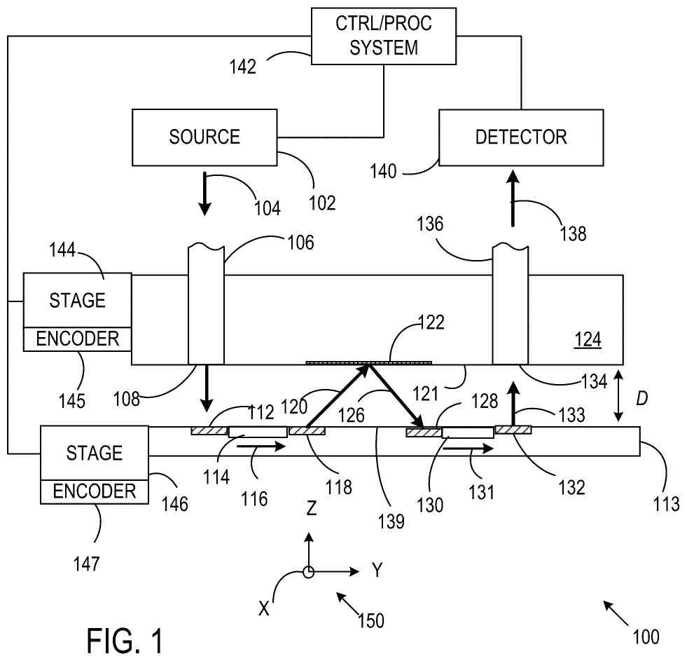

Referring to FIG. 1, a representative alignment system 100 includes an optical beam source 102 such as a laser that is situated to direct an optical beam 104 to an optical fibre 106 of a multiport optical probe 124 that defines a first optical port 108 as a surface of the optical fibre 106. The optical beam 104 is then incident on a waveguide grating coupler (WGC) 112 of a photonic integrated circuit (PIC) 113 that directs the optical beam 104 into a first waveguide section 114 to form a guided beam 116. The guided beam 116 propagates to a second waveguide grating coupler 118 that diffracts the guided beam to form an unguided beam 120 that is incident to reflectively coated area 122 on a probe face 121 of the multiport optical probe 124. A reflected optical beam 126 is incident to a third waveguide grating coupler 128 to produce a guided optical beam 131 that propagates in a second waveguide section 130 to a fourth waveguide grating coupler 132. The fourth waveguide grating coupler 132 directs a diffracted portion of this guided optical beam to form an unguided optical beam 133 that is received at a second optical port 134 of the multiport optical probe 124 that is defined by a second optical fibre 136. The optical fibre 136 couples an associated optical beam 138 to a photodetector 140, which generates a detector signal from the associated optical beam 138. A control or processing system 142 coupled to the photodetector 140 receives and processes the detector signal.

The detector signal permits estimation or determination of a separation D between the probe face 121 and the PIC 113, referred to hereafter as a PIC-probe distance. As shown in FIG. 1, the reflected optical beam 126 is incident to the waveguide grating coupler 128. Increasing or decreasing the PIC-probe distance D tends to reduce optical power in the optical beam 138, reducing a detector signal magnitude. For example, if the PIC-probe distance D is increased, the reflected optical beam 126 will tend to be incident to a surface of the PIC 113 associated with the third waveguide section 130 and will be less well coupled (or not coupled at all) into the third waveguide section 130. Similarly, if the PIC-probe distance D is decreased, the reflected optical beam 126 will tend to be incident to the PIC 113 in an area 139 and not the third waveguide grating coupler 128, reducing or eliminating coupling of the reflected optical beam 126 into the second waveguide section 130 and reducing power in the optical beam 138. The PIC 113 is coupled to stage 146 and encoder 147 that are coupled to the control and processing system 142 for adjustment of PIC-probe distance D (a Z-direction in a coordinate system 150) as well as translation along X- and Y-directions, and rotations if necessary. The multiport optical probe 124 can be secured to a stage 144 and encoder 145 that are coupled to the control and processing system 142 for adjustment of PIC-probe distance D as well. One or both of the PIC 113 and the multiport optical probe 124 can be repositioned as may be convenient and respective stages and encoders are not required.

In the example of FIG. 1, a coated area 122 is used to produce a reflected beam. In some examples, the probe face 121 is sufficiently reflective and a coating is not needed. FIG. 1 shows a multiport optical probe having only two optical ports but more can be provided. Depending on positions of the optical ports, a reflected beam such as the reflected beam 126 can be produced by reflection from a probe face generally and/or at one or more optical probe ports.

### Example 2

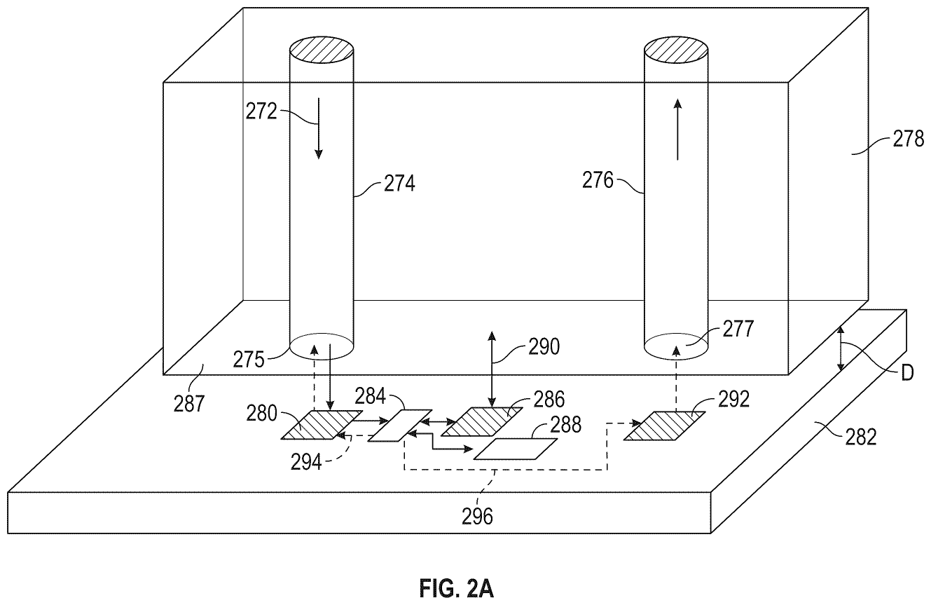

Referring to FIG. 2A, an optical beam 272 is directed to an optical fibre 274 and output from a first optical port 275. The optical fibre 274 and an optical fibre 276 that defines a second optical port 277 are representative optical fibres of a multiport optical probe 278 that can have additional optical fibres and optical ports. The optical beam 272 is emitted from the first optical port 275 to a first waveguide grating coupler 280 defined on a waveguide circuit 282, such as a PIC. The waveguide circuit 282 receives the optical beam 272 at the first waveguide grating coupler 280 and produces an optical beam in a waveguide that is then directed to a beam splitter 284. The beam splitter 284 couples a first beam portion of the guided beam to a second waveguide grating coupler 286 and a second beam portion of the guided beam to a reflector 288 that is defined on the waveguide circuit 282. The first beam portion is then reflected at a probe face 287 of the multiport optical probe 278 as shown at 290 and returns to the second waveguide grating coupler 286. Optical beams returned from the reflector 288 and the probe face 287 are combined at the beam splitter 284 which directs a first portion of the combined optical beam portion 294 back to the first waveguide grating coupler 280 and a second portion of the combined optical beam portion 296 along a waveguide (not shown) to a third waveguide grating coupler 292. The second portion of the combined optical beam portion 296 received by the third waveguide grating coupler 292 is directed to the second optical port 277 and can be coupled to a detector by the second optical fibre 276. The first portion of the combined optical beam portion 294 received by the first waveguide grating coupler 280 is directed to the first optical port 275 and can be coupled to a detector by the first optical fibre 274. Interference of either one of the combined beams can be used to determine a waveguide device-probe distance D as the interference is a function of an optical path difference associated with optical propagation to and from the reflector 288 and to and from the probe face 287.

FIG. 2B illustrates a system 200 for establishing PIC-probe distance using optical interference. For purposes of illustration, a multiport optical probe 210 is shown in a sectional view while a PIC 212 is shown in a plan view. A perspective view would be similar to that of FIG. 2A. The system 200 includes a wavelength tunable optical beam source 202 that is situated to couple an optical beam 204 from a first optical port 206 associated with a first optical fibre 208A of the multiport optical probe 210. The optical beam 204 is coupled into a waveguide 216 of the PIC 212 by a waveguide grating coupler 213 so that a guided optical beam 217 is received by a beam splitter 218. The beam splitter 218 directs a first portion 220 of the guided optical beam 217 via a waveguide section 224 to a reflector 226 which produces a reflected beam 228 that is returned to the beam splitter 218. The beam splitter 218 also couples a second portion 230 of the guided optical beam 217 to a second waveguide grating coupler 232 which emits an unguided beam 234 to a reflective area 236 on a probe face 238 of the multiport optical probe 210. The reflective area 236 can be a polished or coated area of the probe face 238 and can include portions of one or more optical ports 206B-206E that are associated with optical fibres 208B-208E, respectively. The unguided beam 234 is at least partially reflected as an externally reflected optical beam 240 back to the waveguide grating coupler 232 to produce a guided optical beam 242 that is coupled to the beam splitter 218.

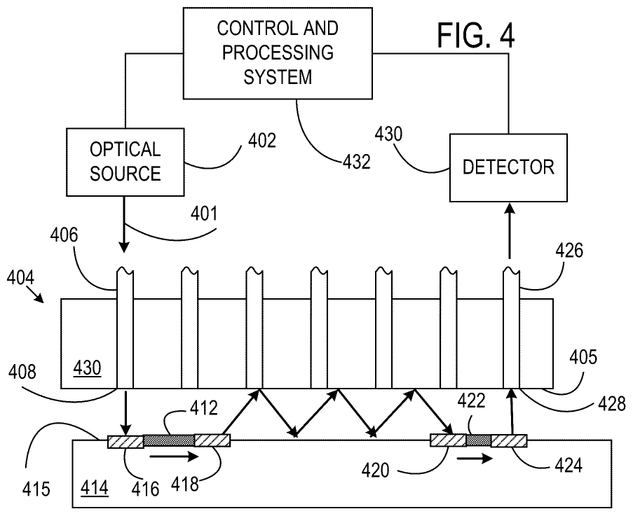

As shown, the beam splitter 218 receives optical beam portions that are associated with an optical path to and from the reflective area 236 and to and from the reflector 226. These optical beam portions are combined by the beam splitter 218 to produce combined beams that can produce interference signals upon detection. Portions 228A, 242A of the optical beams 228, 242 are coupled by the beam splitter 218 via waveguide section 244 to a third grating coupler 246 and output as a combined optical beam 248A. Similarly, portions 228B, 242B of the optical beams 228, 242 are coupled by the beam splitter 218 into the waveguide section 216 and to the first waveguide grating coupler 213 and output as a combined optical beam 248B. In this example, the combined optical beam 248B could be used instead of or in addition to the combined optical beam 242A in establishing the PIC-probe distance. An exemplary embodiment that uses a combination of optical beams 242A and 242B in establishing the PIC-probe distance is discussed further in reference to FIG. 5 below.

The combined optical beam 248A is received at a second optical port 206F and propagates via an associated optical fibre 208F to an optical detector 250 that produces a detector signal in response. The detector signal is coupled to a control and processing system 252 that is also coupled to the tunable beam source 202. The tunable beam source 202 is operable to produce the optical beam 204 as a variable wavelength optical beam such as a swept wavelength optical beam or an optical beam having wavelength that is stepped to different values at different times. The combined beams 248A, 248B produce interference signals that are functions of optical path differences associated with reflection of the optical beam 234 a probe face 238 of the multiport optical probe 210 and reflection of the guided optical beam 220 by the reflector 226. The interference signals are also functions of optical beam wavelength.

### Example 3

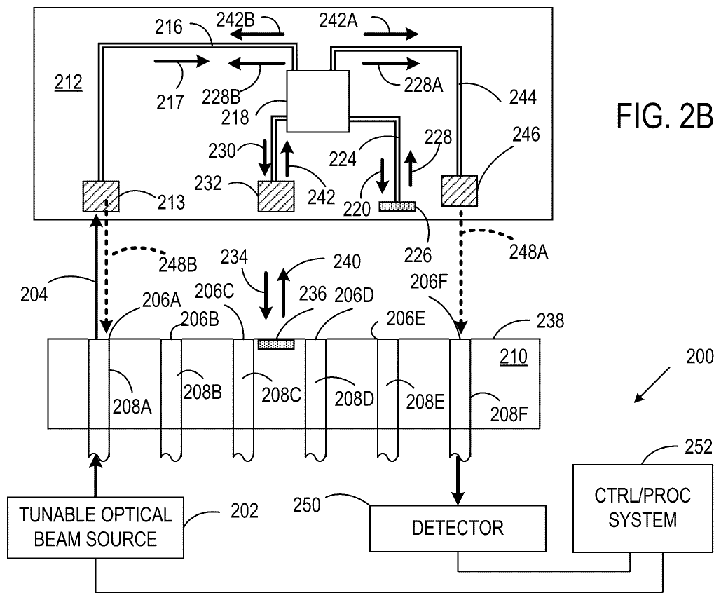

Distance determination based on interfering optical beams is illustrated in FIGS. 3A-3B. FIG. 3A illustrates calculated detector signals produced by interference between on-PIC and off-PIC reflected beams as a function of wavelength for path differences of 30 μm, 60 μm, and 100 μm. More rapid amplitude variation for shorter path differences (i.e., PIC-probe distances) is apparent. FIG. 3B shows Fourier transforms of the calculated detector signals of FIG. 3 illustrating peaks corresponding to the path differences, which can be used to estimate PIC-probe separation. In this example, a wavelength range of about 1290 nm to 1360 nm is used, but other wavelength ranges can be used as convenient. Wider wavelength ranges tend to permit more accurate determinations of PIC-probe distance.

### Example 4

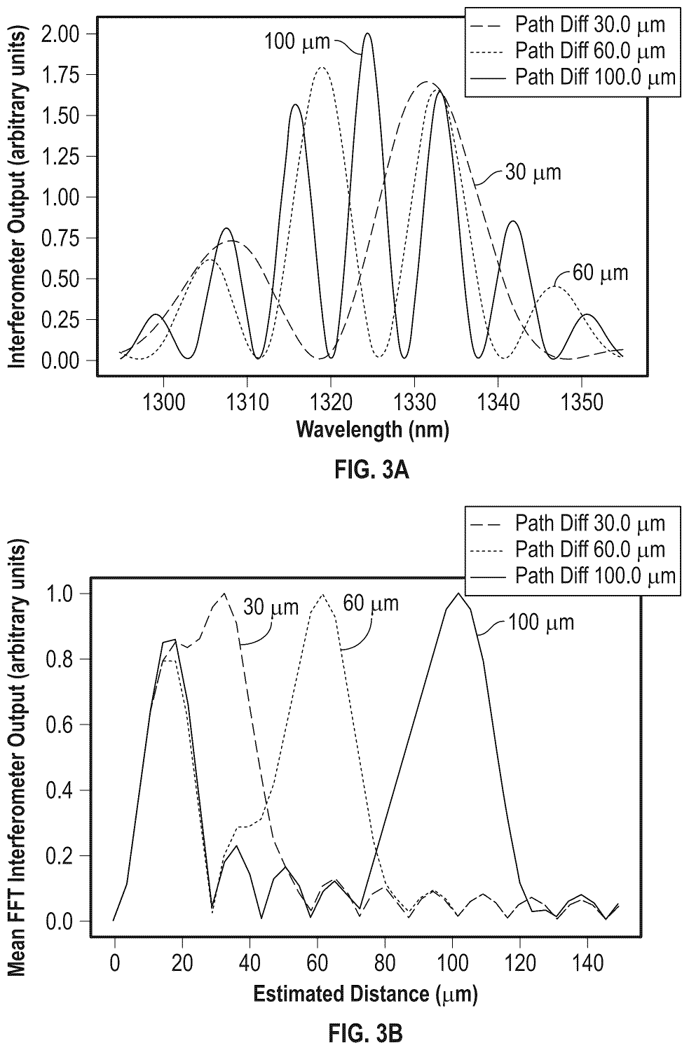

Referring to FIG. 4, a multiport optical probe 404 is situated to receive an optical beam 401 from an optical source 402 at a first waveguide 406 and output the optical beam at a first optical port 408. The multiport optical probe 404 includes additional optical ports and waveguides such as a second waveguide 426 and a second optical port 428. The waveguides of the multiport optical probe 404 are fixed with respect to each other by a support matrix 430. The optical beam is coupled into a first waveguide section 412 of a PIC 414 at a first waveguide grating coupler 416. After propagation as a guided optical beam in the first waveguide section 412, the optical beam is emitted from the PIC 414 at a second waveguide grating coupler 418 and is reflected multiple times by a surface 415 of the PIC 414 and a surface 405 of the multiport optical probe 404. At least some portions of either or both of the surfaces 405, 415 can be provided with a dielectric or metallic or other reflective material. Alternatively, the surfaces 405, 415 can be sufficiently smooth and/or polished to promote Fresnel reflections. After multiple reflections, the optical beam is directed into a second waveguide section 422 by a second waveguide grating coupler 420 and then exits the PIC 414 at a third waveguide grating coupler 424. The second optical port 428 receives the exiting optical beam and directs the optical beam to a detector 430. A control and/or processing system 432 is coupled to the optical source 402 and the detector 430 to control, for example, optical source power, wavelength, frequency variations, and to receive detector signals and provide filtering, amplification, Fourier transformations, or other operations.

### Example 5

FIG. 5 illustrates a multiport optical probe 508 in a sectional view and a PIC 514 in a plan view for convenient illustration. Referring to FIG. 5, a tunable optical source 502 is coupled to an optical circulator 504 to direct an optical beam to a first optical port of a first optical fibre 506 of the multiport optical probe 508 which delivers the optical beam to a waveguide coupler 512 on the PIC 514. This produces a guided optical beam 515 that propagates along a first waveguide section 516 to a beam divider 518 that directs a first portion 519 to a second waveguide section 520 and a second waveguide coupler 522 so that the PIC 508 emits an optical beam 523 toward a reflective area 524 of the multiport optical probe 508. A reflected optical beam 525 is directed to the second waveguide coupler 522 to produce a guided beam portion 527 that is coupled to the beam divider 518, producing a first portion that propagates along the first waveguide section 516 toward the first waveguide coupler 512 and a second beam portion that propagates along a third waveguide section 530 to a third waveguide coupler 532. The beam divider 518 also directs a portion 535 of the beam from the first waveguide coupler 512 to a fourth waveguide section 534 and a reflector 536 which produces a reflected beam portion 537 that is directed back to the beam divider 518 to produce a portion directed along the first waveguide section 516 toward the first waveguide coupler 512 and a portion directed along the third waveguide section 530 to the third waveguide coupler 532. In this arrangement, combined beams 540A, 540B contain beam portions from each of the reflective area 524 and the reflector 536 are directed to a first optical port 507 associated with the first optical fibre and a second optical port 557 associated with a second optical fibre 556, respectively. Thus, optical interference can be detected with the combined optical beams exiting at either the first waveguide coupler 512 or the third waveguide coupler 532. In FIG. 5, the combined optical beam 540B is coupled by the optical circulator 504 to a detector 554 to produce a detector signal that is coupled to a control and processing system 556. The control and processing system 556 is also coupled to select one or more emission wavelengths to be produced by the tunable optical beam source 502. The control and processing system 536 is operable to perform Fourier transforms to establish PIC/probe spacing and to adjust positions and orientations of one or more of the multiport optical probe 508 and the PIC 514 using one or more stages 558.

### Example 6

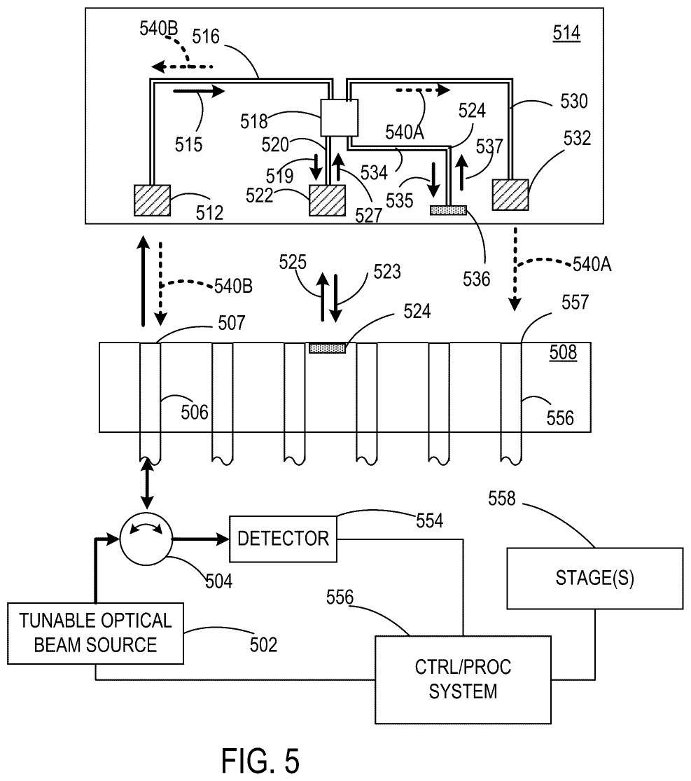

Referring to FIG. 6, a method 600 includes directing an optical beam from a first optical port to a waveguide circuit at 602 and coupling the optical beam into a first waveguide section at 604. At 606, the corresponding guided optical beam from the first waveguide section is emitted from the waveguide circuit and reflected at an external reflector such as a surface of a multiport optical probe support matrix, an optical port, or other external surface or reflector. At 610, the reflected optical beam is coupled into a second waveguide section and at 612, the optical beam from the second waveguide section is emitted to a second optical port. A detector is situated to receive the emitted beam and produce a detector signal which is used to determine PIC-probe distance at 614. If the distance is not satisfactory as determined at 614, an adjustment is made at 616 and the measurement sequence is repeated. If satisfactory, the method 600 terminates.

### Example 7

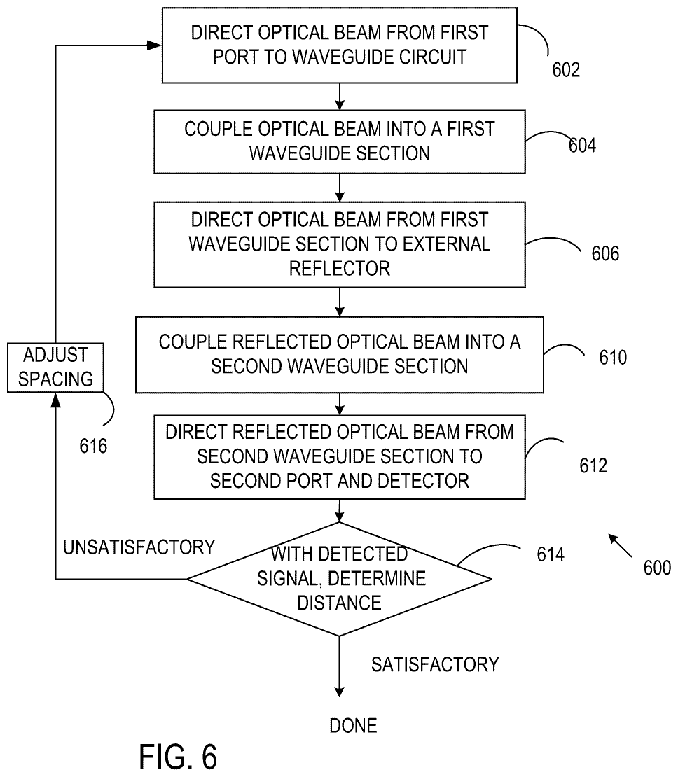

FIG. 7 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like as well as with FPGAs, ASICs, Complex Programmable Logic Devices (CPLDs), or other dedicated processors. The disclosed technology may also be practiced in distributed computing environments where tasks are performed by remote processing devices that are linked through a communications network. In a distributed computing environment, program modules may be located in both local and remote memory storage devices. As used herein, storage and storage devices refer to physical devices and not transitory storage or signals.

With reference to FIG. 7, an exemplary system for implementing the disclosed technology includes a general-purpose computing device in the form of an exemplary conventional PC 700, including one or more processing units 702, a system memory 704, and a system bus 706 that couples various system components including the system memory 704 to the one or more processing units 702. The system bus 706 may be any of several types of bus structures including a memory bus or memory controller, a peripheral bus, and a local bus using any of a variety of bus architectures. The exemplary system memory 704 can include read only memory (ROM) and random-access memory (RAM) and a basic input/output system (BIOS) containing the basic routines that help with the transfer of information between elements within the PC 700, can be stored in ROM. The memory 704 also contains portions 771-774 that include computer-executable instructions and data for wavelength tuning, interference signal processing and acquisition (such as filtering, amplifying), distance estimation based on detector signals, and positioning of a multiport optical probe or a PIC.

The exemplary PC 700 further includes one or more storage devices 730 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 706 by a hard disk drive interface, a magnetic disk drive interface, and an optical drive interface, respectively. The drives and their associated computer-readable media provide nonvolatile storage of computer-readable instructions, data structures, program modules, and other data for the PC 700. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 730 including an operating system, one or more application programs, other program modules, and program data. For example, port location data can be stored in a storage device. A user may enter commands and information into the PC 700 through one or more input devices 740 such as a keyboard and a pointing device such as a mouse. Other input devices may include a digital camera, microphone, joystick, game pad, satellite dish, scanner, or the like. These and other input devices are often connected to the one or more processing units 702 through a serial port interface that is coupled to the system bus 706 but may be connected by other interfaces such as a parallel port, game port, or universal serial bus (USB). A monitor 746 or other type of display device is also connected to the system bus 706 via an interface, such as a video adapter. Other output devices 748 such as speakers and printers, may be included.

The PC 700 may operate in a networked environment using logical connections to one or more remote computers, such as a remote computer 760. In some examples, one or more network or communication connections 750 are included for wired or wireless communication as well as data acquisition and control such as digital-to-analog convertors and analog-to-digital convertors. The remote computer 760 may be another PC, a server, a router, a network PC, or a peer device or other common network node, and typically includes many or all of the elements described above relative to the PC 700, although only a memory storage device 762 has been illustrated in FIG. 7. The personal computer 700 and/or the remote computer 760 can be connected to a local area network (LAN) and a wide area network (WAN). Such networking environments are commonplace in offices, enterprise-wide computer networks, intranets, and the Internet.

When used in a LAN networking environment, the PC 700 is connected to the LAN through a network interface. When used in a WAN networking environment, the PC 700 typically includes a modem or other means for establishing communications over the WAN, such as the Internet. In a networked environment, program modules depicted relative to the personal computer 700, or portions thereof, may be stored in the remote memory storage device or other locations on the LAN or WAN. The network connections shown are exemplary, and other means of establishing a communications link between the computers may be used.

### Example 8

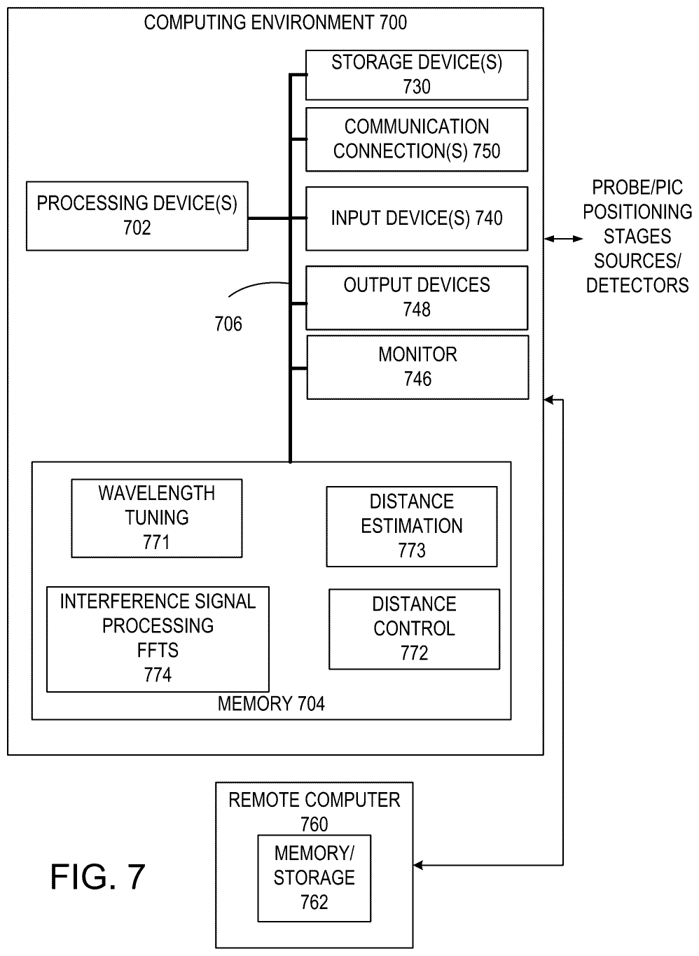

Referring to FIG. 8, a representative method 800 includes directing an optical beam from first optical fiber to first grating coupler at 802. At 804, the optical beam is propagated in waveguide section defined in a PIC and at 806, the optical beam is received by a second grating coupler. At 808, the optical beam is directed to an external surface such as a multiport optical probe face for reflection. At 810, the reflected optical beam is received at third grating coupler and propagated in a PIC waveguide section. At 812, the optical beam is directed to a fourth grating coupler and at 814, the fourth grating coupler directs the optical beam to a second optical fibre. At 816, the optical beam is directed to a detector and a detector signal is obtained. At 818, based on the detector signal, a PIC-probe distance is evaluated. The PIC-probe distance can be adjusted as needed at 822 or distance measurement and/or adjustment terminated at 824.

### Example 9

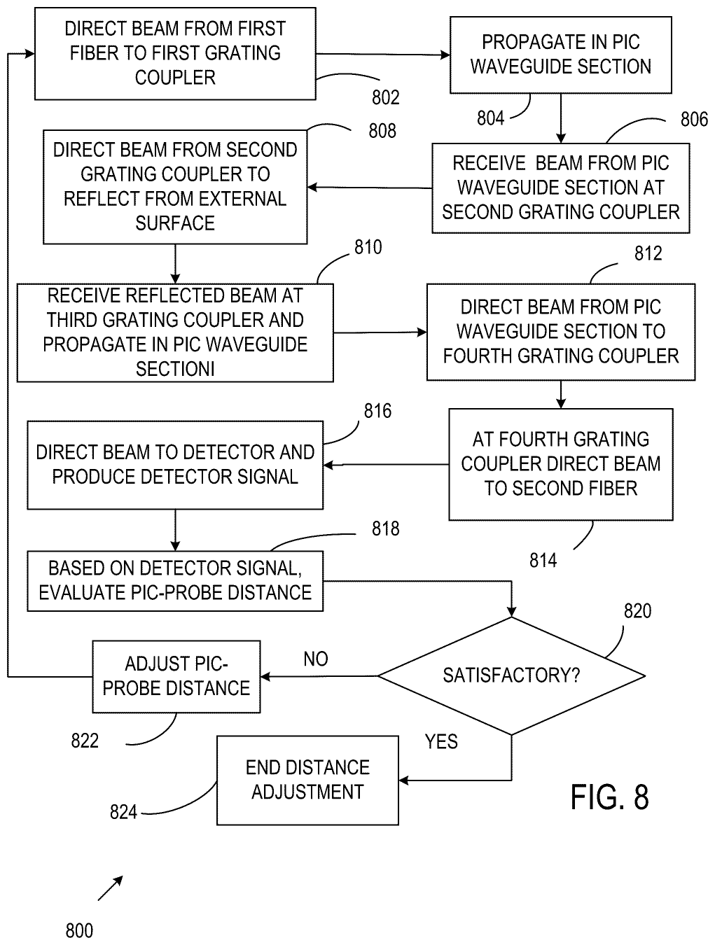

Referring to FIG. 9, a representative method 900 includes directing a variable wavelength optical beam from first optical port of multiport optical probe to a first grating coupler at 902 and propagating the optical beam in a waveguide defined in PIC at 904. At 906, first and second beam portions are formed from the original optical beam. At 908, the first beam portion is directed to an external reflector and the second beam portion is directed along an optical path on the PIC that can include a reflector. At 910, an interference signal is recorded. Based on the interference signal, PIC-probe distance is determined at 912. If PIC-probe distance is determined to be satisfactory, the method 900 terminates to 920. If the PIC-probe distance is not satisfactory, it is adjusted at 916 and measurement is repeated.

### Example 10

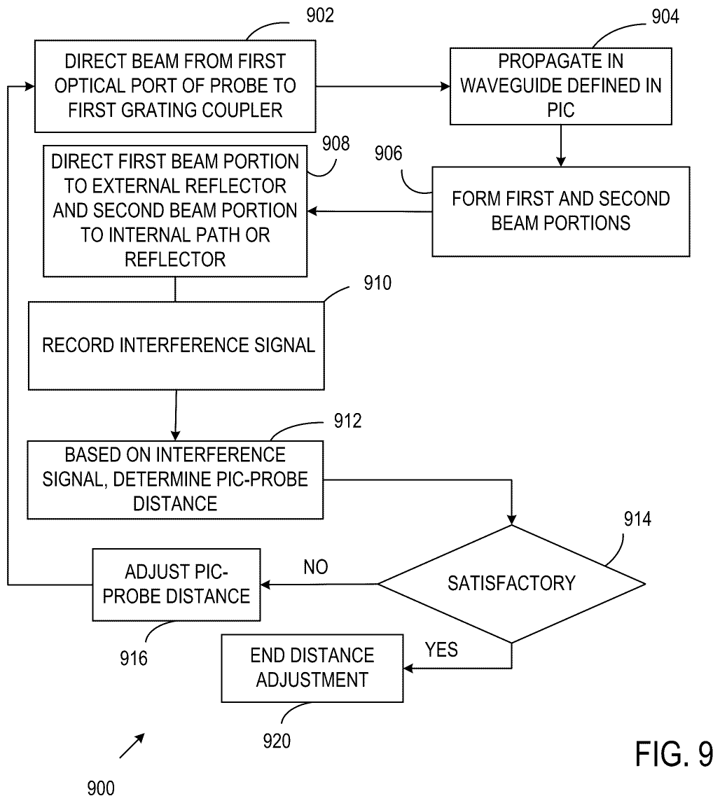

Referring to FIG. 10, a representative method 1000 includes directing an optical beam to a waveguide circuit at 1004 and emitting a guided beam portion from the waveguide circuit and reflecting this portion back into the waveguide circuit as a guided beam at 1006. At 1008, the guided beam associated with the reflected beam portion is output to a detector and a waveguide circuit-probe distance is determined based on the detector signal at 1010.

### Example 11

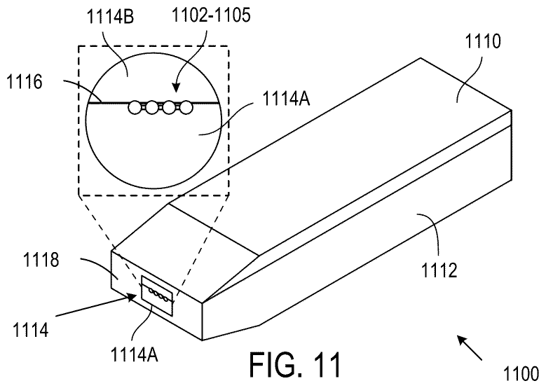

PIC-probe distances can also be measured and adjusted using optical beams produced and/or detected on a PIC. Referring to FIG. 12, a representative alignment system 1200 includes an optical beam source 1202 such as a laser diode or light emitting diode that is situated on a PIC 1213. The optical beam source 1202 directs an optical beam 1216 along first waveguide section 1214 to a first waveguide grating coupler 1218. The first waveguide grating coupler 1218 diffracts the guided beam to form an unguided beam 1220 that is incident to reflectively coated area 1222 on a probe face 1221 of a multiport optical probe 1224. A reflected optical beam 1226 is incident to a second waveguide grating coupler 1228 to produce a guided optical beam 1231 that propagates in a second waveguide section 1230 to a third waveguide grating coupler 1232. The third waveguide grating coupler 1232 directs a diffracted portion of this guided optical beam to form an unguided optical beam 1233 that is received at an optical port 1234 defined by an optical fibre 1236. The optical fibre 1236 couples an associated optical beam 1238 to a photodetector 1240. A control or processing system 1242 receives a detector signal from the photodetector 1240. The control or processing system 1242 is coupled to the optical source 1202 via electrodes or other electrical connections 1241. As discussed above, the detector signal permits estimation or determination of a separation D between the probe face 1221 and the PIC 1213.

### Example 12

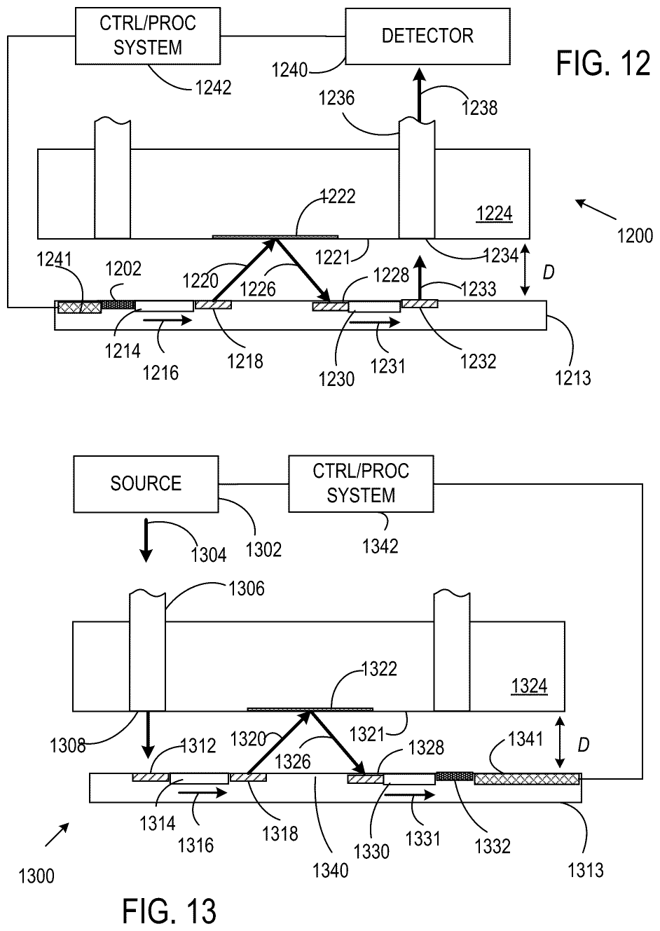

Referring to FIG. 13, a representative alignment system 1300 includes an optical beam source 1302 such as a laser that is situated to direct an optical beam 1304 to an optical fibre 1306 of a multiport optical probe 1324 that defines a first optical port 1308 as a surface of the optical fibre 1306. The optical beam 1304 is then incident to a first waveguide grating coupler 1312 of a photonic integrated circuit (PIC) 113 that directs the optical beam 1304 into a first waveguide section 1314 to form a guided beam 1316. The guided beam 1316 propagates to a second waveguide grating coupler 1318 that diffracts the guided beam 1316 to form an unguided beam 1320 that is incident to reflectively coated area 1322 on a probe face 1321 of the multiport optical probe 1324. A reflected optical beam 1326 is incident to a third waveguide grating coupler 1328 to produce a guided optical beam 1331 that propagates in a second waveguide section 1330 to an on-PIC photodetector 1332. A control or processing system 1342 receives a detector signal via electrodes or other electrical connections 1341 and probe-PIC distance D can be determined or adjusted as discussed above.

### Disclosure Clauses

Clause 1 is a method, including: directing an optical beam from a first optical port into a photonic integrated circuit (PIC) so that the optical beam propagates as a first guided optical beam; directing a portion of the first guided optical beam from the PIC to an external reflector to produce a reflected optical beam; receiving the reflected optical beam at the PIC and propagating at least a portion of the reflected optical beam as a second guided optical beam; and directing a portion of the second guided optical beam from the PIC to an optical detector operable to produce a detected optical signal; and based on the detected optical signal, establishing a spacing of the PIC with respect to at least one optical port.

Clause 2 includes the subject matter of Clause 1, and further specifies that the portion of the second guided optical beam is directed from the PIC to a second optical port that is coupled to the optical detector, wherein the established spacing is a separation of the PIC and at least one of the first optical port and the second optical port.

Clause 3 includes the subject matter of any of Clauses 1-2, and further specifies that the optical beam from the first optical port is coupled to the PIC by a first waveguide grating coupler.

Clause 4 includes the subject matter of any of Clauses 1-3, and further specifies that: the portion of the first guided optical beam is directed from the PIC to the external reflector by a second waveguide grating coupler; and the reflected optical beam from the external reflector is received at a third waveguide grating coupler defined on the PIC to produce the second guided optical beam.

Clause 5 includes the subject matter of any of Clauses 1-4, and further specifies that the first optical port and the second optical port are defined by a multiport optical probe.

Clause 6 includes the subject matter of any of Clauses 1-5, and further specifies that, the first optical port and the second optical port are defined at a probe face of the multiport optical probe, the first optical port and the second optical port are associated with a first optical waveguide and a second optical waveguide, respectively, wherein the first optical waveguide and a second optical waveguide are secured by a fiber support matrix, and the external reflector is defined by a portion of the probe face.

Clause 7 includes the subject matter of any of Clauses 1-6, and further specifies that the external reflector is defined by a reflective coating on at least a portion of the fiber support matrix.

Clause 8 includes the subject matter of any of Clauses 1-7, and further specifies that: the first optical port and the second optical port are associated with a first optical waveguide and a second optical waveguide, respectively, wherein the first optical waveguide and a second optical waveguide are secured by a fiber support matrix, and the external reflector is defined by a portion of a fiber support matrix surface or by a portion of a third optical port defined on probe face or by both.

Clause 9 includes the subject matter of any of Clauses 1-7, and further specifies that the multiport optical probe defines a plurality of optical ports including the first optical port and the second optical port, wherein the first optical port and the second optical port are non-adjacent optical ports.

Clause 10 includes the subject matter of any of Clauses 1-9, and further specifies that: the portion of the first guided optical beam directed from the PIC to the external reflector is a first portion of the first guided optical beam, a second portion of the first guided optical beam and the portion of the second guided optical beam from the PIC are coupled to the optical detector so that the detected optical signal is an interference signal, and the spacing between the PIC and at least one of the first optical port and second optical port is established based on the interference signal.

Clause 11 includes the subject matter of any of Clauses 1-10, and further includes: varying a wavelength of the optical beam directed from the first optical port into the PIC to produce interference signals associated with a plurality of wavelengths; and establishing the spacing based on the interference signals.

Clause 12 includes the subject matter of any of Clauses 1-11, and further specifies that the first optical port and the second optical port are defined by surfaces of respective optical fibers.

Clause 13 is an apparatus, including: an optical source situated to emit an optical beam from a first optical port that directs the emitted optical beam to a photonic integrated circuit (PIC) to propagate as a guided optical beam at the PIC; a detector situated to receive an externally reflected first portion of the guided optical beam from the PIC and produce a corresponding detector signal; and a processor operable to establish a spacing of the PIC based on the detector signal.

Clause 14 includes the subject matter of Clause 13, and further includes a multiport optical probe that includes a fiber support matrix, wherein the first optical port is defined at surface of the fiber support matrix and the externally reflected first portion of the guided optical beam from the PIC is associated with reflection at the multiport optical probe.

Clause 15 includes the subject matter of any of Clauses 14, and further specifies that the detector is situated to receive the externally reflected first portion from a second optical port defined by the multiport optical probe.

Clause 16 includes the subject matter of any of Clauses 13-14, and further specifies that: the detector is situated to receive a second portion of the optical beam and produce an interference signal with the externally reflected first portion, and the processor is operable to establish the spacing of the fiber support matrix surface and the PIC based on the interference signal.

Clause 17 includes the subject matter of any of Clauses 13-16, and further specifies that the optical source is operable to emit an optical beam at a plurality of wavelengths and the processor is operable to establish the spacing of a probe face of a multiport optical probe and the PIC based on a corresponding plurality of interference signals.

Clause 18 includes the subject matter of any of Clauses 13-17, and further specifies that the detector is situated to receive the second portion of the optical beam and the externally reflected first portion at a second optical port defined by the multiport optical probe.

Clause 19 includes the subject matter of any of Clauses 13-18, and further specifies that the detector is situated to receive the second portion of the optical beam and the externally reflected first portion from the first optical port.

Clause 20 includes the subject matter of any of Clauses 13-19, and further includes an optical circulator situated to: receive the emitted optical beam from the optical source and couple the emitted optical beam to the first optical port and couple the second portion of the optical beam and the externally reflected first portion from the first optical port to the detector.

Clause 21 is an apparatus, including: an optical source operable to produce an optical beam; a multiport optical probe having a probe face defining a plurality of optical ports associated with corresponding optical waveguides, the multiport optical probe situated to: emit the optical beam at a first probe port and direct the optical beam to propagate as a first guided optical beam in a waveguide circuit, reflect a portion of the first guided optical beam as an emitted optical beam from the waveguide circuit back to the waveguide circuit to propagate as a second guided optical beam, wherein the portion is reflected the probe face, and receive a portion of the second guided optical beam emitted from the waveguide circuit at a second optical port; and a detector coupled to the second optical port and operable to produce a detected optical signal.

In view of the many possible embodiments to which the principles of the disclosed technology may be applied, it should be recognized that the illustrated embodiments are only preferred examples and should not be taken as limiting the scope of the disclosure.

We claim:

1. A method, comprising:
directing an optical beam from a first optical port of a multiport optical probe toward a photonic integrated circuit (PIC) to produce a first guided optical beam in the PIC;
directing a portion of the first guided optical beam from the PIC to a reflector to produce a reflected optical beam;
receiving the reflected optical beam at the PIC and causing at least a portion of the reflected optical beam to propagate in the PIC as a second guided optical beam; and
directing a portion of the second guided optical beam from the PIC to an optical detector to produce a detected optical signal; and
based on the detected optical signal, establishing a spacing of the PIC with respect to the first optical port.

2. The method of claim 1, wherein the portion of the second guided optical beam is directed from the PIC to the optical detector via a second optical port of the multiport optical probe that is optically coupled to the optical detector.

3. The method of claim 1, wherein the optical beam from the first optical port is coupled to the PIC by a first waveguide grating coupler.

4. The method of claim 3, wherein:
the portion of the first guided optical beam is directed from the PIC to the reflector by a second waveguide grating coupler; and
the reflected optical beam from the reflector is received at a third waveguide grating coupler defined on the PIC to produce the second guided optical beam.

5. The method of claim 1, wherein, the multiport optical probe includes a second optical port, the first optical port and the second optical port are defined at a probe face of the multiport optical probe,
the first optical port and the second optical port are associated with a first optical waveguide and a second optical waveguide, respectively, wherein the first optical waveguide and the second optical waveguide are secured by a fiber support matrix.

6. The method of claim 5, wherein the reflector is defined by a reflective coating on at least a portion of the fiber support matrix.

7. The method of claim 5, wherein the first optical port and the second optical port are non-adjacent optical ports.

8. The method of claim 1, wherein:
the portion of the first guided optical beam directed from the PIC to the reflector is a first portion of the first guided optical beam,
a second portion of the first guided optical beam and the portion of the second guided optical beam from the PIC are coupled to the optical detector so that the detected optical signal is an interference signal, and
the spacing between the PIC and the first optical port is established based on the interference signal.

9. The method of claim 1 comprising:
varying a wavelength of the optical beam directed from the first optical port toward the PIC to produce interference signals associated with a plurality of wavelengths; and
establishing the spacing between the PIC and the first optical port based on the interference signals.

10. An apparatus, comprising:
a processor operable to:
receive a detector signal; and
based on the detector signal, establish a spacing between a photonic integrated circuit (PIC) and a first optical port of a multiport optical probe; and
an optical source situated to emit an optical beam;
wherein:
the detector signal is associated with light from the optical beam that has been directed to a PIC through a first optical port of a multiport optical probe to produce a guided optical beam, at least a first portion of the guided optical beam is reflected to provide a reflected optical beam and at least a portion of the reflected optical beam is directed to an optical detector.

11. The apparatus of claim 10 comprising the multiport optical probe wherein the multiport optical probe includes a fiber support matrix, wherein the first optical port is defined at a surface of the fiber support matrix and the reflected optical beam is associated with reflection at the multiport optical probe.

12. The apparatus of claim 11 comprising the detector, wherein the detector is situated to receive the portion of the reflected optical beam from a second optical port of the multiport optical probe.

13. The apparatus of claim 12, wherein:
the detector is situated to receive a second portion of the optical beam and produce an interference signal based on the second portion of the optical beam and the reflected optical beam, and
the processor is operable to establish the spacing between the PIC and the first optical port of the multiport optical probe based on the interference signal.

14. The apparatus of claim 13 comprising an optical circulator situated to:
receive the emitted optical beam from the optical source and couple the emitted optical beam to the first optical port, and
couple the second portion of the optical beam and the reflected first portion of the guided optical beam to the detector.

15. The apparatus of claim 10, wherein the optical source is operable to emit the optical beam at a plurality of wavelengths and the processor is operable to establish the spacing between the PIC and the first optical port of the multiport optical probe based on a corresponding plurality of interference signals.

16. An apparatus, comprising:
an optical source operable to produce an optical beam;
a multiport optical probe having a probe face defining a plurality of optical ports associated with corresponding optical waveguides, the multiport optical probe situated to:
receive the optical beam and direct the optical beam through a first optical port of the plurality of optical ports to a waveguide circuit such that the optical beam propagates as a first guided optical beam in the waveguide circuit,
reflect a portion of the first guided optical beam such that the portion of the first guided optical beam propagates as a second guided optical beam in the waveguide circuit; and
receive, at a second optical port of the plurality of optical ports, a portion of the second guided optical beam from the waveguide circuit;
a detector coupled to the second optical port and operable to produce a detector signal based on the portion of the second guided optical beam; and
a processor operable to receive the detector signal and determine a spacing between the multiport optical probe and the waveguide circuit based on the detector signal.

17. The apparatus of claim 16 comprising a positioning stage coupled to at least one of the multiport optical probe and the waveguide circuit and operable to adjust the spacing between the multiport optical probe and the waveguide circuit.

18. The apparatus of claim 16, wherein the optical source is a tunable optical source.
